(19) United States
(12) Patent Application Publication
(10) Pub. No.: US 2025/0211045 A1
(43) Pub. Date: Jun. 26, 2025

(54) WOUND FIELD MOTOR

(71) Applicant: TOYOTA JIDOSHA KABUSHIKI KAISHA, Toyota-shi (JP)

(72) Inventors: Daiki YAMADA, Toyota-shi (JP); Kenta TABUCHI, Nisshin-shi (JP)

(73) Assignee: TOYOTA JIDOSHA KABUSHIKI KAISHA, Toyota-shi (JP)

(21) Appl. No.: 18/830,587

(22) Filed: Sep. 11, 2024

(30) Foreign Application Priority Data
Dec. 20, 2023 (JP) 2023-214830

(51) Int. Cl. H02K 3/24; H02K 1/26

(52) U.S. Cl. CPC H02K 3/24; H02K 1/26

(57) ABSTRACT

The disclosure relates to a wound field motor. The wound field motor includes a rotor, a coil wound around the rotor, and an end ring attached to a coil end of the coil and supplied with a cooling medium, and at least one through hole is provided in an axial end face of the end ring.

### CROSS-REFERENCE TO RELATED APPLICATION

This application claims priority to Japanese Patent Application No. 2023-214830 filed on Dec. 20, 2023, incorporated herein by reference in its entirety.

### BACKGROUND

### 1. Technical Field

The present disclosure relates to wound field motors.

### 2. Description of Related Art

A wound field motor is disclosed in which an axial surface of an end ring attached to a rotor has a through hole.

### SUMMARY

However, in the technique proposed in Japanese Unexamined Patent Application Publication (Translation of PCT Application) No. 2019-536411 (JP 2019-536411 A), a cooling medium may flow into an air gap (clearance) between a rotor and a stator, which may cause an increase in drag loss.

The present disclosure was made in view of the above, and an object of the present disclosure is to provide a wound field motor that can effectively cool a coil end while reducing drag loss.

A wound field motor according to the present disclosure includes:
a rotor;
a coil wound around the rotor; and
an end ring that is attached to a coil end of the coil and to which a cooling medium is supplied.

An axial end face of the end ring includes at least one through hole.

According to the present disclosure, since the axial end face of the end ring has the through hole, the cooling medium is less likely to flow into an air gap between the rotor and a stator. This allows to effectively cool the coil end while reducing drag loss.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating an exemplary configuration of a rotor of a wound field motor according to an embodiment; and

FIG. 2 is a perspective view illustrating an example of a configuration of a rotor of the wound field motor according to the embodiment.

### DETAILED DESCRIPTION OF EMBODIMENTS

A wound field motor according to an embodiment of the present disclosure will be described with reference to the drawings. Incidentally, the constituent elements in the following embodiments include those that can be easily replaced by a person skilled in the art or those that are substantially the same.

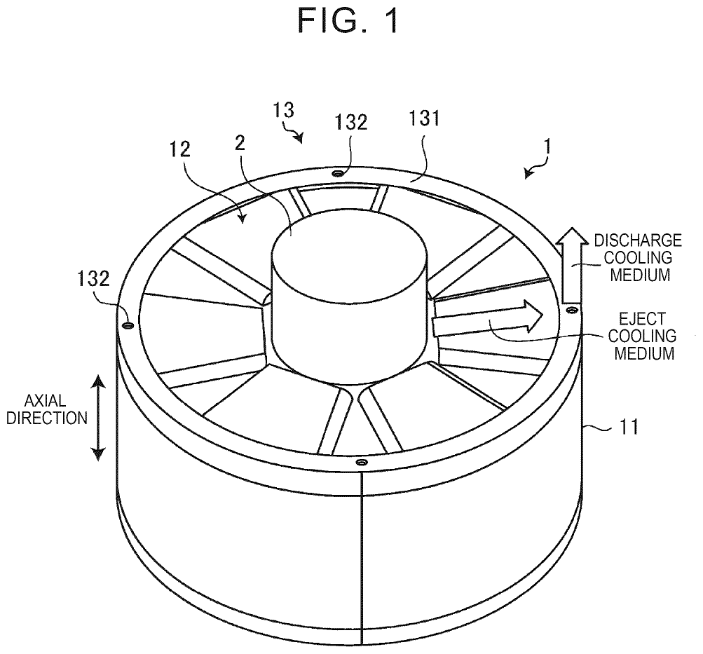

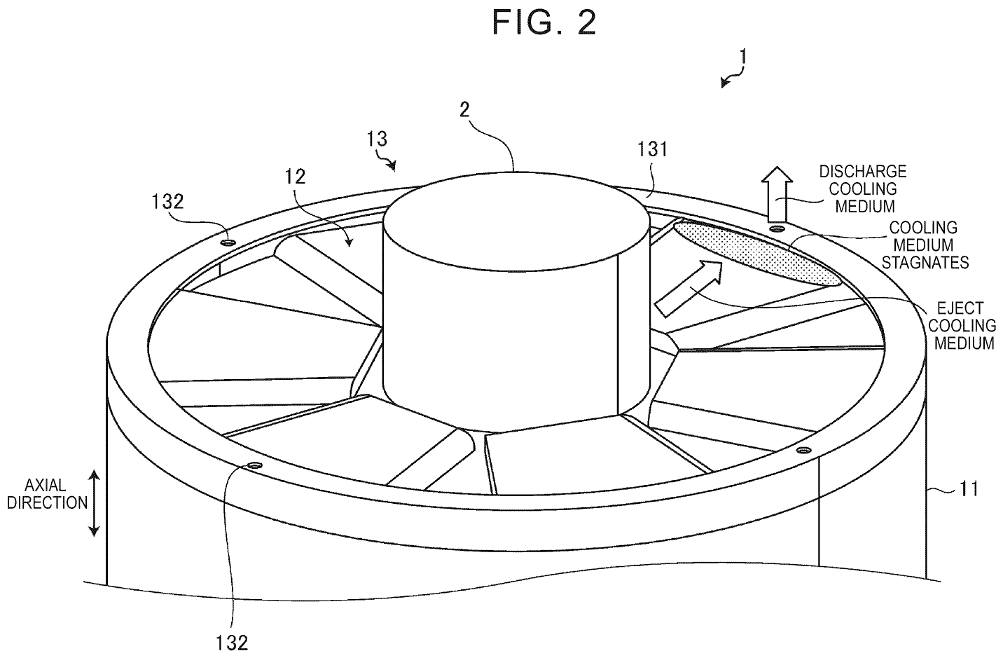

The configuration of the wound field motor according to the embodiment will be described with reference to FIGS. 1 and 2. The wound field motor according to the embodiment is, for example, a power source of a vehicle. The wound field motor according to the embodiment is mounted on, for example, hybrid electric vehicle (HEV), plug-in hybrid electric vehicle (PHEV), or the like. Further, the wound field motor according to the embodiment may be mounted on, for example, fuel cell electric vehicle (FCEV), battery electric vehicle (BEV), or the like.

The wound field motor according to the embodiment includes a rotor 1, a shaft 2, and a stator. In FIG. 1 and FIG. 2, the stator is not shown. The rotor 1 includes a rotor core 11, a coil 12, and an end ring 13.

The rotor core 11 is formed in a cylindrical shape and is stacked in a plurality of axial directions. The rotor core 11 is provided with a plurality of teeth protruding in the radial direction, and a coil 12 is wound around each tooth. A shaft 2 is attached to the inside of the cylinder of the rotor core 11.

The coil 12 is wound around a plurality of teeth of the rotor core 11. The coil 12 wound around the plurality of teeth is filled with a thermosetting resin. The coil end of the coil 12 is exposed from the thermosetting resin.

The end ring 13 is attached to an axial end portion of the coil 12 (hereinafter, referred to as a “coil end”). The end ring 13 functions as a strength member against centrifugal force, and also functions as a member for improving cooling efficiency of the coil end. Further, the end ring 13 includes an annular flange portion 131 which is a radially flat portion.

A cooling medium (for example, oil or the like) is supplied from a cooling medium supply device (not shown) into the end ring 13. The specific configuration of the cooling medium supply device is not particularly limited, but may be, for example, a device provided with a nozzle for directly injecting the cooling medium to the coil end, or a device for supplying the cooling medium to the shaft 2. For example, as shown in FIG. 1, when the cooling medium is injected from the cooling medium supply device toward the coil end, the cooling medium is supplied into the flange portion 131 of the end ring 13 and stays by the centrifugal force when the rotor 1 rotates. As a result, the coil end can be covered with the cooling medium, and the coil end can be cooled.

At least one through hole 132 is provided in the axial end face of the end ring 13, that is, the flange portion 131. A total of four through holes 132 are provided in FIG. 1, but may be three or less in total, or five or more in total, depending on, for example, the amount of cooling medium to be supplied into the end ring 13.

The through hole 132 is for discharging the cooling medium staying in the end ring 13 to the outside. The through hole 132 is provided so as to penetrate the flange portion 131. As shown in the figure, the cooling medium that has stayed in the end ring 13 for a certain period of time is discharged from the through hole 132.

The shaft 2 is attached to the rotor core 11 via a bearing (not shown) or the like. The shaft 2 is fixed to the rotor core 11 and is configured to be rotatable integrally with the rotor core 11.

Here, for example, in the case of the end ring without the flange portion 131 as in the present embodiment (not the flange structure), since the cooling medium does not stay in the end ring, the cooling medium does not sufficiently cover the coil end, the cooling efficiency is deteriorated. Further, for example, when the through hole is not provided in the end ring, since the cooling medium is not circulated, the cooling medium whose temperature is increased continues to stay in the end ring, the cooling efficiency is deteriorated.

On the other hand, in the wound field motor according to the embodiment, by providing the through hole 132 in the axial end face of the end ring 13, that is, the flange portion 131, it is possible to suppress the cooling medium from flowing into the air gap between the rotor 1 and the stator. This makes it possible to effectively cool the coil end while reducing drag loss.

That is, in the wound field motor according to the embodiment, the end ring 13 that complements the centrifugal strength of the rotor 1 has a flange structure in which the cooling medium is accumulated, so that in addition to the strength complementing effect, the cooling capacity improving effect can be provided, and deterioration in the electric cost can be suppressed. Further, by setting the through hole 132 for discharging the cooling medium to the end ring 13 in the axial direction, the circulation of the cooling medium is promoted.

Further advantages and variations can be readily derived by one of ordinary skill in the art. Thus, the broader aspects of the disclosure are not limited to the specific details and representative embodiments presented and described above. Accordingly, various modifications may be made without departing from the spirit or scope of the general inventive concept as defined by the appended claims and their equivalents.

What is claimed is:

1. A wound field motor comprising:
a rotor;
a coil wound around the rotor; and
an end ring that is attached to a coil end of the coil and to which a cooling medium is supplied, wherein an axial end face of the end ring includes at least one through hole.
